(19) United States
(12) Patent Application Publication
(10) Pub. No.: US 2015/0061412 A1
(43) Pub. Date: Mar. 5, 2015

(54) APPARATUS AND METHOD FOR CONTROLLING DIRECTION OF MANIPULATION OF CONTROL BUTTON OF TERMINAL

(71) Applicant: ELECTRONICS AND TELECOMMUNICATIONS RESEARCH INSTITUTE, Daejeon-city (KR)

(72) Inventors: Byoungchul CHOI, Daejeon (KR); Sungyoung JUNG, Daejeon (KR); Seokji PARK, Daejeon (KR); Jinbo SIM, Daejeon (KR); Hyunmi BAEK, Seoul (KR); Yuna RO, Daejeon (KR); Wanseok KIM, Daejeon (KR)

(73) Assignee: ELECTRONICS AND TELECOMMUNICATIONS RESEARCH INSTITUTE, Daejeon-city (KR)

(21) Appl. No.: 14/339,907

(22) Filed: Jul. 24, 2014

(30) Foreign Application Priority Data
Sep. 3, 2013 (KR) 10-2013-0105352

(51) Int. Cl. H04M 1/725; H01H 9/54

(52) U.S. Cl. CPC H04M 1/7258; H01H 9/54; H01H 2231/022; H01H 2217/00
USPC 307/134

(57) ABSTRACT

An apparatus and method for controlling the direction of manipulation of a control button of a terminal are disclosed. The apparatus includes a position detection unit and a direction control unit. The position detection unit detects the position of a terminal based on a signal of a sensor. The direction control unit changes the direction of manipulation of a control button physically attached to the terminal and adapted to receive various types of control commands from a user in response to the detected position of the terminal.

### CROSS REFERENCE TO RELATED APPLICATION

This application claims the benefit of Korean Patent Application No. 10-2013-0105352, filed Sep. 3, 2013, which is hereby incorporated by reference herein in its entirety.

### BACKGROUND OF THE INVENTION

1. Technical Field

The present disclosure relates generally to an apparatus and method for controlling the direction of manipulation of a control button of a terminal and, more particularly, to an apparatus and method that are capable of providing the consistent direction of manipulation of a control button to a user even when the position of a terminal, such as a smartphone, has changed.

2. Description of the Related Art

In general, when a terminal, such as a smartphone or a smartpad, is manipulated, the direction of manipulation of a control button is the same in connection with hardware regardless of whether the body of the terminal is in a normal position or whether the position of the body has changed from a normal position.

For example, when a smart terminal has been turned upside down from a normal position, the direction of manipulation of a control button changes from the direction from the left to the right to the direction from the right to the left from the point of view of a user. That is, during the use of the smart terminal, the direction of manipulation of the control button has changed due to a change in the direction of the body of the smart terminal from the point of view of the user, and thus the user becomes confused or suffers from inconvenience. In some cases, a smart terminal manipulation error occurs.

Korean Patent Application Publication No. 10-2005-0087941 discloses a portable electronic device and method for changing the state of menu display in response to the rotation of the portable electronic device. However, almost no technology for changing the direction of manipulation of a control button of a terminal has been disclosed so far.

### SUMMARY OF THE INVENTION

Accordingly, at least one embodiment of the present invention is intended to provide an apparatus and method that detect a change in the position of the body of a terminal, such as a smartphone, based on a sensor such as a gyro sensor, and then provides the consistent direction of manipulation of a control button to a user in response to the change in the position of the body.

In accordance with an aspect of the present invention, there is provided an apparatus for controlling the direction of manipulation of a control button of a terminal, including a position detection unit configured to detect the position of a terminal based on a signal of a sensor; and a direction control unit configured to change a direction of manipulation of a control button physically attached to the terminal and adapted to receive various types of control commands from a user in response to the detected position of the terminal.

The apparatus may further include an interface unit configured to provide an interface to the user so that the user sets the direction of manipulation of the control button corresponding to a change in the position of the terminal and to receive setting information related to the direction of manipulation of the control button from the user via the interface.

The setting information may include one or more of direction control mode selection information and actual target manipulation direction information associated with the direction control mode selection information.

The direction control mode selection information may include one or more of information about the application of a basic control button manipulation direction provided by the terminal, information about the application of a control button manipulation direction to be applied based on the signal of the sensor, and information about the application of a control button manipulation direction set by the user as desired.

Once the position of the terminal has been detected, the direction control unit may determine whether the position of the terminal has changed, and may change the direction of manipulation of the control button if the position of the terminal has changed.

Once the position of the terminal has been detected, the direction control unit may calculate a displacement from a previous position of the terminal, and may determine that the position of the terminal has changed if the calculated displacement exceeds a threshold value.

The sensor may include a gyro sensor.

In accordance with another aspect of the present invention, there is provided a method of controlling the direction of manipulation of a control button of a terminal, including detecting the position of a terminal based on a signal of a sensor; and changing a direction of manipulation of a control button physically attached to the terminal and adapted to receive various types of control commands from a user in response to the detected position of the terminal.

The method may further include providing an interface to the user so that the user sets the direction of manipulation of the control button corresponding to a change in the position of the terminal; and receiving setting information related to the direction of manipulation of the control button from the user via the interface.

The setting information may include one or more of direction control mode selection information and actual target manipulation direction information associated with the direction control mode selection information.

The direction control mode selection information may include one or more of information about the application of a basic control button manipulation direction provided by the terminal, information about the application of a control button manipulation direction to be applied based on the signal of the sensor, and information about the application of a control button manipulation direction set by the user as desired.

Once the position of the terminal has been detected, changing the direction of manipulation of the control button may include determining whether the position of the terminal has changed; and changing the direction of manipulation of the control button if the position of the terminal has changed.

Once the position of the terminal has been detected, determining whether the position of the terminal has changed may include calculating a displacement from a previous position of the terminal; and determining that the position of the terminal has changed if the calculated displacement exceeds a threshold value.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for controlling the direction of manipulation of a control button of a terminal according to an embodiment of the present invention;

FIG. 2 is a diagram illustrating an example of the direction of manipulation of a common terminal;

FIG. 3 is a diagram illustrating an example of the direction of manipulation of a control button of a terminal according to an embodiment of the present invention;

FIG. 4 is a flowchart of a method of controlling the direction of manipulation of a control button of a terminal according to an embodiment of the present invention; and

FIG. 5 is a flowchart of a method of entering control button manipulation direction setting information according to an embodiment of the present invention.

### DESCRIPTION OF THE PREFERRED EMBODIMENTS

Reference now should be made to the drawings, throughout which the same reference numerals are used to designate the same or similar components.

An apparatus and method for controlling the direction of manipulation of a control button of a terminal according to embodiments of the present invention are described in detail below with reference to the accompanying drawings.

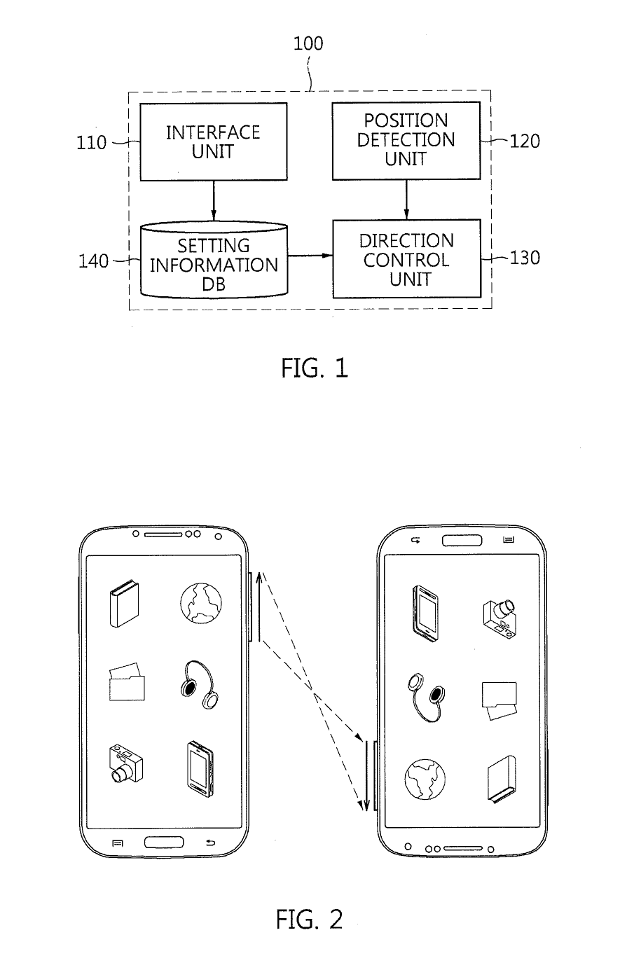

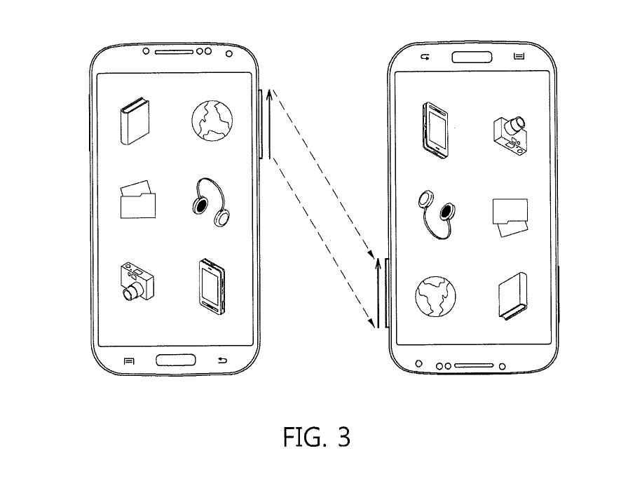

FIG. 1 is a block diagram of an apparatus 100 for controlling the direction of manipulation of a control button of a terminal according to an embodiment of the present invention. FIG. 2 is a diagram illustrating an example of the direction of manipulation of a common terminal. FIG. 3 is a diagram illustrating an example of the direction of manipulation of a control button of a terminal according to an embodiment of the present invention.

Referring to FIG. 1, the apparatus 100 for controlling the direction of manipulation of a control button of a terminal includes an interface unit 110, a position detection unit 120, a direction control unit 130, and a setting information DB 140.

The interface unit 110 provides an interface to a user so that the user may set the direction of manipulation of a control button of a terminal in advance. Furthermore, setting information related to the direction of manipulation of a control button may be received from the user via the interface, and the received setting information may be stored in the setting information DB 140.

In this case, the control button of a terminal is hardware (e.g., a menu button, a volume control button, or the like) physically attached to the terminal and configured to function as a means for receiving various types of control commands from a user. However, the control button of a terminal is not necessarily limited thereto, but may be an icon that is implemented as software and displayed on the display screen of a terminal, if necessary.

The interface unit 110 may apply various entry methods or various entry objects to the interface so that a user may easily enter setting information via the interface.

Meanwhile, the setting information may include direction control mode selection information applicable in response to a change in the position of the terminal, and actual target manipulation direction information applicable for the direction control mode selection information.

In this case, the direction control mode selection information may include information about the selection of a basic control button manipulation direction to be provided by a terminal when the position of the terminal has changed, information about the selection of a control button manipulation direction to be applied based on a signal of a sensor, such as a gyro sensor (a sensor-based control button manipulation direction), and information about the selection of a control button manipulation direction set by the user as desired.

In this case, the basic control button manipulation direction to be provided by the terminal is a control button manipulation direction that is generally set when the terminal is fabricated. Even when the position of the terminal has changed, the basic control button manipulation direction does not change, as illustrated in FIG. 2.

In contrast, if the sensor-based control button manipulation direction or the control button manipulation direction set by the user as desired has been selected, a consistent control button manipulation direction is provided to the user from the point of view of the user when the position of the terminal has changed, as illustrated in FIG. 3.

The sensor-based control button manipulation direction is a control button manipulation direction that may be presumed by most users in connection with the position of the terminal detected by a gyro sensor.

If a control button manipulation direction has been set by the user as desired, whether the position of the user has changed is determined based on a signal of a sensor, and the control button manipulation direction set by the user, rather than the control button manipulation direction generally presumed by most users, is applied in response to the signal of a sensor indicative of a change in the position of the terminal. In this case, the control button manipulation direction sensor signal set by the user may not be immediately applied in response to a change in the position of the terminal, but may be applied only if a condition preset by the user is met.

Via the interface, the user may enter direction control mode selection information as desired, and then may enter actual target manipulation direction information associated with the direction control mode selection information.

In this case, when the user has selected a basic control button manipulation direction provided by the terminal, it is not necessary to set the actual target manipulation direction information because the basic control button manipulation direction of the terminal will be applied.

In contrast, if the user has selected a sensor-based control button manipulation direction, the user may directly enter actual target manipulation direction information to be applied in response to a change in the position of the terminal. However, the user does not necessarily directly enter actual target manipulation direction information. That is, it may be possible to automatically set actual target manipulation direction information using information about a typical direction that is presumed by most users when a change in the position of the terminal, for example, an upside-down change, has been made, if necessary.

For example, referring to FIGS. 2 and 3, when the body of a terminal is in a normal position, as in the left sides of the drawings, the lower part of a volume control button is a volume down part, and the upper part thereof is a volume up part. In this case, when the terminal has been turned upside down, as in the right sides of the drawings, the positions of the volume down part and the volume up part are changed with each other in a common terminal, as illustrated in FIG. 2. In this case, a user becomes confused, and thus a volume control error frequently occurs.

Even when the terminal has been turned upside down, most users often manipulate the volume control button while still considering the lower part of the volume control button to be a volume down part and the upper part of the volume control button to be a volume up part. In contrast, in accordance with this embodiment of the present invention, a setting may be made such that the control button manipulation direction is changed to a direction that is presumed by most users.

Meanwhile, if a control button manipulation direction set by a user as desired has been selected, a user may additionally set a criterion for determining whether the position of the terminal has changed or a control button manipulation direction to be actually applied in response to the position of the terminal.

As an example of the criterion for determining whether the position of the terminal has changed, a user may enter a threshold value via the interface so that the direction of manipulation of a control button is changed if a change in the position of the terminal, that is, a displacement, exceeds the threshold value (e.g., angular information, such as 45 degrees, 90 degrees, or 135 degrees).

Furthermore, the user may set, via the interface, actual target manipulation direction information to be applied if it is determined that the position of the terminal has changed because a threshold value, such as that exemplified as described above, is met.

In this case, as described above, the actual target manipulation direction information to be applied may be set to a control button manipulation direction that will be applied if the sensor-based control button manipulation direction has been selected, that is, a direction presumed by most users, or a control button manipulation direction that is set by a user as desired.

The position detection unit 120 receives a sensor signal from a sensor and then detects the position of the terminal. For example, the position detection unit 120 may determine whether the terminal is in a normal position or an upside-down position by receiving a gyro sensor signal from a gyro sensor module mounted on the terminal or configured to operate in conjunction with the terminal in real time and then analyzing the sensor signal.

Once the position detection unit 120 has detected the current position of the terminal, the direction control unit 130 may change the direction of manipulation of the control button physically attached to the terminal based on the results of the detection.

In this case, once the current position of the terminal has been detected by the position detection unit 120, the direction control unit 130 checks whether direction control mode selection information and actual target manipulation direction information corresponding to the detected position of the terminal are present in the setting information DB 140.

If a user has selected a basic control button manipulation direction, the direction control unit 130 does not change a control button manipulation direction even when the position of the terminal has changed.

If a user has selected a sensor-based control button manipulation direction or a control button manipulation direction set by the user as desired, the direction control unit 130 changes the direction of manipulation of the control button to a direction corresponding to a detected current position.

In this case, the direction control unit 130 may determine that the position of the terminal has been changed from the previous position of the terminal to the detected current position of the terminal, and may change the direction of manipulation of the control button only if it is determined that a change has been made.

Meanwhile, if a user has selected a control button manipulation direction set by the user as desired, the direction control unit 130 additionally checks whether a threshold value is present. If, as a result of the checking, it is determined that a threshold value is present, the direction control unit 130 may calculate the displacement between the detected current position of the terminal and the previous position of the terminal, may determine that the position of the terminal has changed if the displacement exceeds the threshold value, and may then change the direction of manipulation of the control button.

In accordance with the disclosed embodiment, a user may make settings so that the direction of manipulation of a control button is controlled based on various situations, such as a change in the position of the terminal, the extent of the change, etc, so that the user can manipulate the control button in a consistent direction from the point of view of the user regardless of the titling of the terminal, the upside-down position of the terminal, or the like.

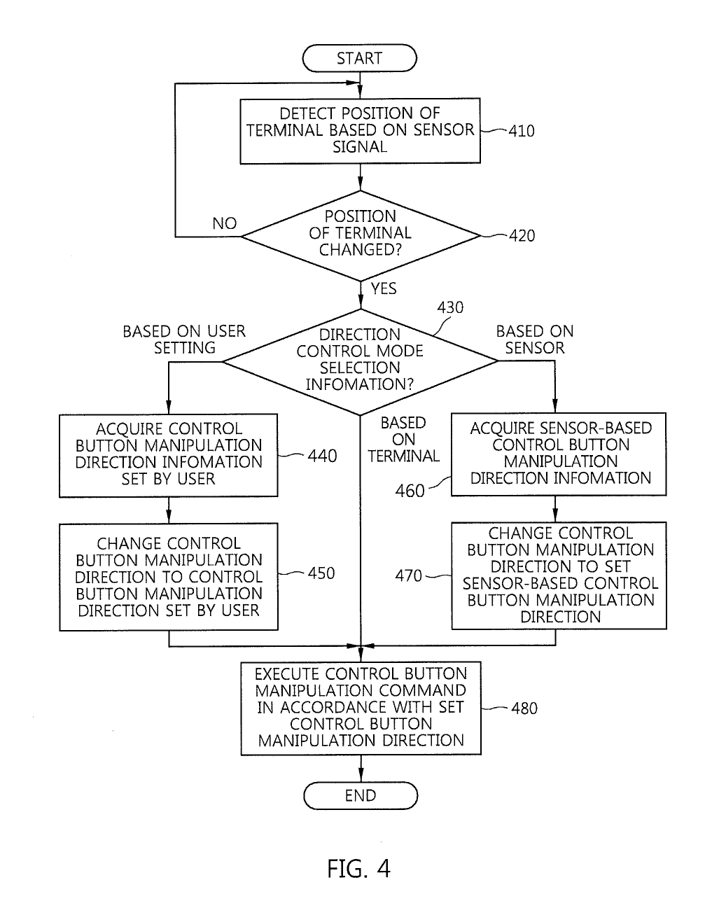

FIG. 4 is a flowchart of a method of controlling the direction of manipulation of a control button of a terminal according to an embodiment of the present invention.

The method illustrated in FIG. 4 may be an example of a method of controlling the direction of manipulation of a control button of a terminal that is performed by the apparatus 100 for controlling the direction of manipulation of a control button of a terminal according to the embodiment illustrated in FIG. 1.

Referring to FIG. 4, in the method of controlling the direction of manipulation of a control button of a terminal, first, when a real-time sensor signal is received from the gyro sensor module of the terminal, the current position of the terminal is detected based on the sensor signal at step 410.

Once the current position of the terminal has been detected at step 410, it is determined whether the position of the terminal has changed at step 420.

Thereafter, if, as a result of the determination at step 420, it is determined that the position of the terminal has changed, it is checked whether direction control mode selection information corresponding to the detected position of the terminal is present in the setting information DB 140 at step 430.

If, as a result of the determination at step 430, it is determined that a user has selected a basic control button manipulation direction, the direction of manipulation of the control button is not changed even when the position of the terminal has changed.

Thereafter, if the user manipulates the control button, a control button manipulation command is received and executed in accordance with the basic control button manipulation direction provided by the terminal at step 480.

Meanwhile, if, as a result of the checking at step 430, the user has selected a control button manipulation direction set by the user as desired, the control button manipulation direction information set by the user is acquired from the setting information DB 140 at step 440, and the control button manipulation direction is changed to a direction corresponding to the detected current position of the terminal at step 450.

In this case, it may be additionally determined whether a threshold value is present. If, as a result of the determination, it is determined that a threshold value is present, it may be determined using the threshold value whether the position of the terminal has changed to the extent that the direction of manipulation of the control button of the terminal needs to be changed.

For example, the displacement between the detected current position of the terminal and the previous position of the terminal may be calculated. If the displacement exceeds the threshold value, it may be determined that the position of the terminal has changed, and then the direction of manipulation of the control button of the terminal may be changed.

If, as a result of the determination at step 430, it is determined that the user has selected a sensor-based control button manipulation direction, actual target manipulation direction information to be applied in connection with a sensor is acquired from the setting information DB at step 460, and the direction of manipulation of the control button is changed based on the acquired actual target manipulation direction information at step 470.

Thereafter, when the user enters a control command by manipulating the control button, the control command may be executed in accordance with the changed direction of manipulation of the control button at step 480.

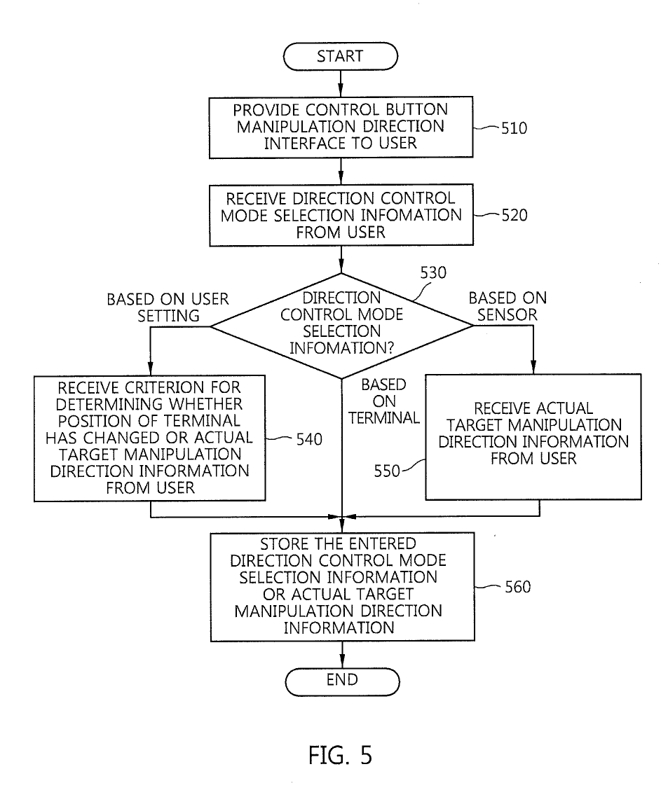

FIG. 5 is a flowchart of a method of entering control button manipulation direction setting information according to an embodiment of the present invention.

The method of entering control button manipulation direction setting information illustrated in FIG. 5 may be performed by the apparatus 100 for controlling the direction of manipulation of a control button of a terminal according to the embodiment illustrated in FIG. 1. Furthermore, in accordance with this embodiment of the present invention, the method of entering control button manipulation direction setting information may be performed prior to the method of controlling the direction of manipulation of a control button of a terminal according to the embodiment illustrated in FIG. 4.

Referring to FIG. 5, in the method of entering control button manipulation direction setting information setting information, first, the apparatus 100 for controlling the direction of manipulation of a control button of a terminal may provide an interface for enabling a user to set the direction of manipulation of a control button of a terminal to the user at step 510.

In this case, the apparatus 100 for controlling the direction of manipulation of a control button of a terminal may apply various entry methods or various entry objects to the interface so that the user can easily enter setting information, including direction control mode selection information inclusive of information about the selection of a basic control button manipulation direction to be provided by the terminal in response to a change in the position of the terminal, the selection of a control button manipulation direction to be applied based on a signal of a sensor, such as a gyro sensor, and the selection of a control button manipulation direction set by the user as desired, and actual target manipulation direction information applicable for the direction control mode selection information.

In this case, the basic control button manipulation direction to be provided by the terminal is a basic control button manipulation direction that is set when the terminal is fabricated. When the sensor-based control button manipulation direction or the control button manipulation direction set by the user as desired has been selected, a control button manipulation direction is changed such that a consistent control button manipulation direction is provided to the user even when the position of the terminal has changed, as illustrated in FIG. 3.

Thereafter, the direction control mode selection information is received from the user via the provided interface at step 520.

Thereafter, the direction control mode selection information entered by the user is checked at step 530. If it is determined that a basic control button manipulation direction provided by the terminal has been selected, the entered direction control mode selection information may be stored in the setting information DB 140 without requiring an additional procedure at step 560.

If, as a result of the checking at step 530, it is determined that a control button manipulation direction set by the user as desired has been selected, a criterion for determining whether the position of the terminal has changed or actual target manipulation direction information applicable in response to a change in the position of the terminal is additionally received from the user via the interface at step 540.

That is, as described above, the user may enter a threshold value as the criterion for determination, and it may be determined that the position of the terminal has changed if a displacement exceeds the threshold value.

Thereafter, the entered direction control mode selection information or actual target manipulation direction information is stored in the setting information DB 140 at step 560.

If, as a result of the checking at step 530, it is determined that a sensor-based control button manipulation direction has been selected, actual target manipulation direction information applicable in response to a change in the position of the terminal is additionally received from the user via the interface at step 550.

However, in this case, it is not necessarily essential to receive the actual target manipulation direction information directly from the user. If there is collected information about a direction that is presumed by most users in response to a change in the position of a terminal, the actual target manipulation direction information may be automatically set based on the collected information.

As described above in conjunction with FIGS. 2 and 3, generally, the lower part of a volume control button is a volume down part and the upper part thereof is a volume up part, and thus a user decreases volume by pressing the lower part and increases volume by pressing the upper part. In this case, even when the terminal has been turned upside down, the direction of manipulation of the volume control button is changed such that the user enters a volume down command using the lower part and a volume up command using the upper part in the same manner, with the result that the user can enter control commands in a consistent direction of manipulation.

In accordance with at least one embodiment, a consistent control button manipulation direction can be provided in a terminal, such as a smartphone, based on a sensor, such as a gyro sensor, so that the confusion and inconvenience of a user related to the direction of manipulation of a control button can be prevented and also control button manipulation errors can be prevented, thereby improving user convenience.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. An apparatus for controlling a direction of manipulation of a control button of a terminal, comprising:
a position detection unit configured to detect a position of a terminal based on a signal of a sensor; and
a direction control unit configured to change a direction of manipulation of a control button physically attached to the terminal and adapted to receive various types of control commands from a user in response to the detected position of the terminal.

2. The apparatus of claim 1, further comprising an interface unit configured to provide an interface to the user so that the user sets the direction of manipulation of the control button corresponding to a change in the position of the terminal and to receive setting information related to the direction of manipulation of the control button from the user via the interface.

3. The apparatus of claim 2, wherein the setting information includes one or more of direction control mode selection information and actual target manipulation direction information associated with the direction control mode selection information.

4. The apparatus of claim 3, wherein the direction control mode selection information includes one or more of information about application of a basic control button manipulation direction provided by the terminal, information about application of a control button manipulation direction to be applied based on the signal of the sensor, and information about application of a control button manipulation direction set by the user as desired.

5. The apparatus of claim 1, wherein the direction control unit, once the position of the terminal has been detected, determines whether the position of the terminal has changed, and changes the direction of manipulation of the control button if the position of the terminal has changed.

6. The apparatus of claim 5, wherein the direction control unit, once the position of the terminal has been detected, calculates a displacement from a previous position of the terminal, and determines that the position of the terminal has changed if the calculated displacement exceeds a threshold value.

7. The apparatus of claim 1, wherein the sensor includes a gyro sensor.

8. A method of controlling a direction of manipulation of a control button of a terminal, comprising:
detecting a position of a terminal based on a signal of a sensor; and
changing a direction of manipulation of a control button physically attached to the terminal and adapted to receive various types of control commands from a user in response to the detected position of the terminal.

9. The method of claim 8, further comprising:
providing an interface to the user so that the user sets the direction of manipulation of the control button corresponding to a change in the position of the terminal; and
receiving setting information related to the direction of manipulation of the control button from the user via the interface.

10. The method of claim 9, wherein the setting information includes one or more of direction control mode selection information and actual target manipulation direction information associated with the direction control mode selection information.

11. The method of claim 10, wherein the direction control mode selection information includes one or more of information about application of a basic control button manipulation direction provided by the terminal, information about application of a control button manipulation direction to be applied based on the signal of the sensor, and information about application of a control button manipulation direction set by the user as desired.

12. The method of claim 8, wherein changing the direction of manipulation of the control button comprises, once the position of the terminal has been detected:
determining whether the position of the terminal has changed; and
changing the direction of manipulation of the control button if the position of the terminal has changed.

13. The method of claim 12, wherein determining whether the position of the terminal has changed comprises, once the position of the terminal has been detected:
calculating a displacement from a previous position of the terminal; and
determining that the position of the terminal has changed if the calculated displacement exceeds a threshold value.
